(19) United States
(12) Patent Application Publication
(10) Pub. No.: US 2021/0025770 A1
(43) Pub. Date: Jan. 28, 2021

(54) APPARATUS FOR MONITORING SAFETY OF TIE DOWN STRAPS

(71) Applicant: Richard Sanders, Goddard, KS (US)

(72) Inventor: Richard Sanders, Goddard, KS (US)

(21) Appl. No.: 16/522,672

(22) Filed: Jul. 26, 2019

(51) Int. Cl. G01L 5/04; G01L 5/10

(52) U.S. Cl. CPC G01L 5/045; G01L 5/103; G01L 5/047

(57) ABSTRACT

Apparatus for monitoring performance of tie down straps are disclosed. A tie down strap is attached to a strap monitor. The strap monitor continuously monitors the physical parameters of the tie down strap. Further, an electronic device communicatively coupled to the strap monitor receives physical parameters of the tie down strap from the strap monitor to determine performance of the tie down strap. Furthermore, upon determining any issues with the performance of the tie down strap, a user is alerted of the issue by the electronic device.

### BACKGROUND

Ratchet straps, also known as tie down straps are fasteners used to hold down cargo or equipment during transport. Ratchet straps are ideal for a number of tie-down applications, like securing loads to vehicles and keeping construction materials in place. While tie down straps have several advantages, there are certain pitfalls as well.

Between 2011-2014, road debris was a factor in a total of more than 200,000 police-reported crashes, resulting in approximately 39,000 injuries and 500 deaths in the United States. The numbers will be much higher if other countries are taken into consideration, especially the developing and underdeveloped countries. Road debris can be extremely dangerous to motorists, especially on roadways where cars travel at high speeds and have less time to react to objects in the road. Many debris-related crashes are preventable. According to research, two in three debris-related crashes result from items falling from a vehicle due to improper maintenance or an unsecured load. Common types of road debris include parts becoming detached from the vehicle (e.g. tires and wheels), unsecured cargo (e.g. furniture and appliances), and tow trailers becoming separated and hitting other vehicles

When goods are tied to vehicles using fasteners like ratchet straps, cables, and wires, the chances of these fasteners to fail tends to be very high due to constant movement of the vehicle during transportation. Even if the goods are securely strapped around, they may tend to loosen up over time due to rattling of vehicle, poor quality of strap, weather conditions, and the like. Constant monitoring of straps is required to make sure that accidents do not happen. It will be much more efficient and effective if technology can be used to monitor the performance of straps that are used to tie goods/cargo to avoid human judgmental errors.

### BRIEF DESCRIPTION OF THE DRAWINGS

Examples are described in the following detailed description and in reference to the drawings, in which:

FIG. 1 is a perspective view 100 of a safety monitoring apparatus for strap-based fasteners.

FIG. 2 is a perspective view 200 of an apparatus for monitoring safety of ratchet straps.

FIG. 3 is a cross-sectional view 300 of the safety monitoring apparatus for strap-based fasteners.

FIG. 4-8 are illustrative diagrams of an electronic device running an application to monitor and control safety of strap-based fasteners.

### DETAILED DESCRIPTION

Strap-based fasteners like ratchet straps, cables, and the like are used extensively for tying up and securing goods for transportation. Strap-based fasteners are extensively used worldwide in multiple modes of transportation including trains, ships, airplanes, buses, trucks, and the like. There are many types of straps and strap materials that may be used in securing goods to vehicles. Strapping may be performed by using materials including steel, polypropylene, polyester, nylon, paper, coir, and the like. The type and strength of strapping material is chosen according the requirements on a case to case basis.

According to the European Commission Transportation Department it has been estimated that up to 25% of accidents involving trucks can be attributable to inadequate cargo securing. Cargo that is improperly secured can cause severe accidents and lead to the loss of cargo, lives, and vehicles, or cause environmental hazards. Strapping, also known as bundling and banding, is the process of applying a strap to an item to combine, stabilize, hold, reinforce, or fasten it. The strap may also be referred to as strapping and remains as one of the most popular method for securing goods and cargo for transportation.

Examples described herein may improve safety of goods strapped onto vehicles for transportation. The examples described herein describes an apparatus (strap monitor) for continuously monitoring the health of straps and alerting a user via an electronic device upon detecting changes in physical properties of straps that may affect secure transportation and storage of goods and cargo. The electronic device may be used to communicate with the strap monitor and alert the user upon detecting any issue with the straps or the cargo secured by the straps. Further, the user may also set customized threshold values for monitoring the health of straps based on the type of straps. Thus, the examples described herein may enhance the reliability and utility of straps used for securing goods/cargo for transportation.

In the following description, for purposes of explanation, numerous specific details are set forth in order to provide a thorough understanding of the present techniques. It will be apparent, however, to one skilled in the art that the present apparatus, devices, and systems may be practiced without these specific details. Reference in the specification to “an example” or similar language means that a particular feature, structure, or characteristic described may be included in at least that one example, but not necessarily in other examples.

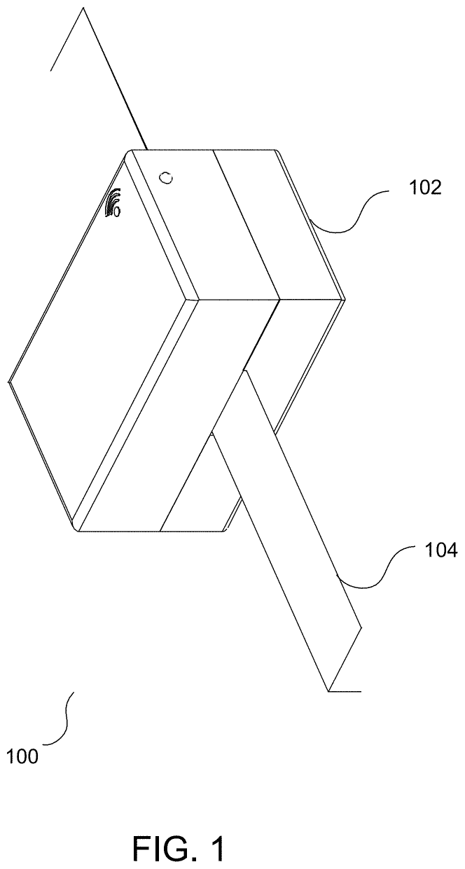

Referring to figures, FIG. 1 is a perspective view 100 of a safety monitoring apparatus for strap-based fasteners. A strap monitor 102 is attached to a tie down strap 104. The strap monitor 102 may be attached to different types of straps including steel-based straps, nylon-based straps, polypropylene-based straps, ratchet straps, and the like. The tie down strap 104 may be made of different types of materials and the materials may be chosen based on the requirements and environment of transportation. In one example, if heavy objects like iron bars are being transported, the tie down strap 104 that is used for securing the iron bars may be made of steel. In another example, a ratchet strap may be used if the goods are moderately heavy and are to be tied up in a truck. Examples described herein are merely exemplary and does not limit the scope of the invention in any way.

The strap monitor 102 may comprise of one or more sensors to continuously monitor and determine the physical parameters of the tie down strap 104 that it is attached with. In one example, the strap monitor 102 may measure parameters such as tensile strength, shear stress, tensile yield stress, and the like. Furthermore, the strap monitor 102 is communicatively connected to an electronic device and transmits data associated with the strap continuously to the electronic device. The strap monitor 102 may be connected to the electronic device via wireless communication means such as General Packet Radio Service (GPRS), Wi-Fi, Bluetooth, GSM based communication such as 3G, 4G, 5G, and the like. The strap monitor 102 may continuously send data associated with the tie down strap 104 to the electronic device for further processing.

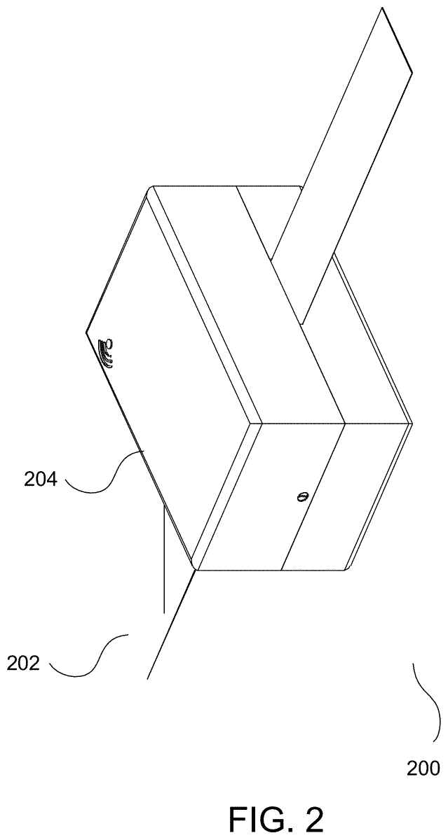

FIG. 2 is a perspective view 200 of an apparatus for monitoring safety of ratchet straps. Herein, a strap monitor 202 is attached to a ratchet strap 204 for continuously monitoring the physical parameters of the ratchet strap such as tensile yield stress.

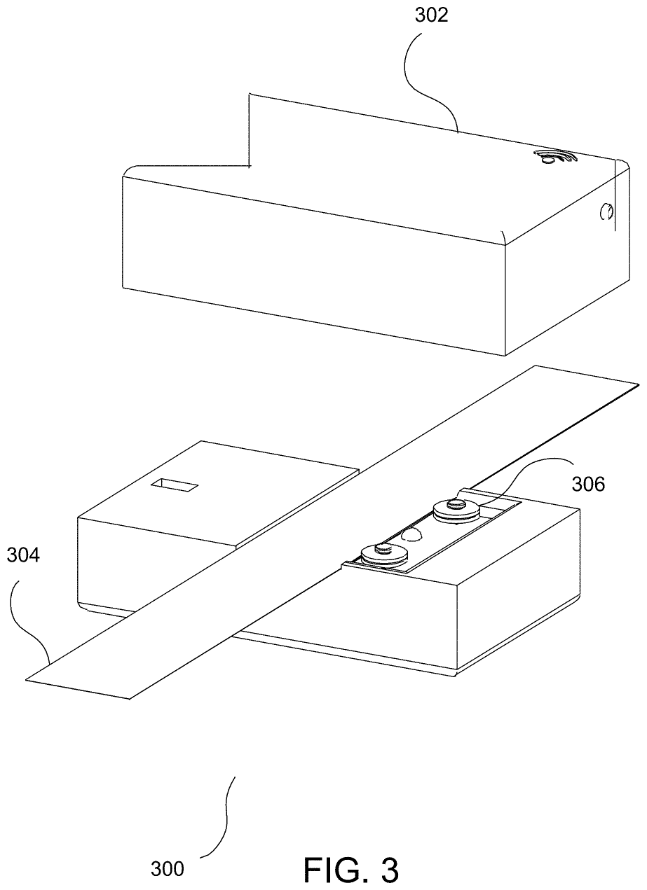

FIG. 3 is a cross-sectional view 300 of a safety monitoring apparatus for strap-based fasteners. A strap monitor 302 may be attached to any strap 304 as shown in the figure. Sensors 306 may be mounted close to the strap 304 to collect data associated with it. The sensors may measure tension on the straps, they may also be referred to as tension meters. A three roller system may be used herein the strap may travel through the rollers causing deflection in the center roller that may be connected to an analog indicator or a load cell in the present invention.

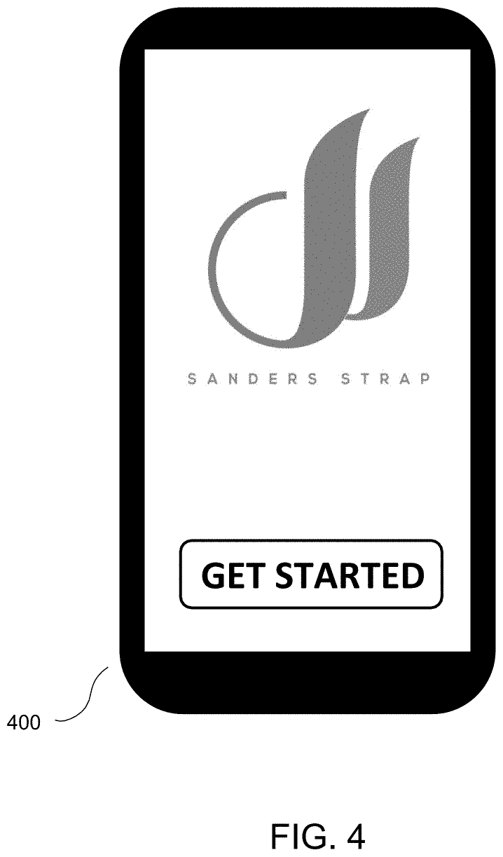

FIGS. 4-8 are illustrative diagrams of an electronic device running an application to monitor and control safety of strap-based fasteners. The electronic device is communicatively coupled with the strap monitor and receives data associated with the strap continuously from the strap monitor. The electronic device used herein may be a smartphone, a tablet, a phablet, a personal digital assistant (PDA), and the like. An application may be loaded to the memory of the electronic device for monitoring the safety of straps and alerting a user when there is any issue related to the strap or the cargo tied with the strap.

FIG. 4 shows an illustrative screenshot 400 for a welcome screen of the application that monitors performance of straps. The electronic device may be communicatively coupled to the strap monitor that is attached to the strap. In one example, the strap monitor 102 attached to the strap 104 may be communicatively coupled to the electronic device. The communication may take place wirelessly via commonly known wireless technologies. Sensor data obtained by the strap monitor may be continuously received by the electronic device. For each strap, a user may pre-set a particular range of value for which corresponding conditions may be set. In one example, for a strap X, a tensile yield strength (TYS) less than 20 may mean that the strap has failed/broken. If the YTS is less than 50, it may mean that the strap is loose, and the goods may fall. If the YTS is greater than 80, it may mean that the strap is very tight and may result in failure of the strap due to high tension. Such conditions may be pre-set for each strap and corresponding user alerts may be received upon detecting that changes in TYS values received from the strap monitor.

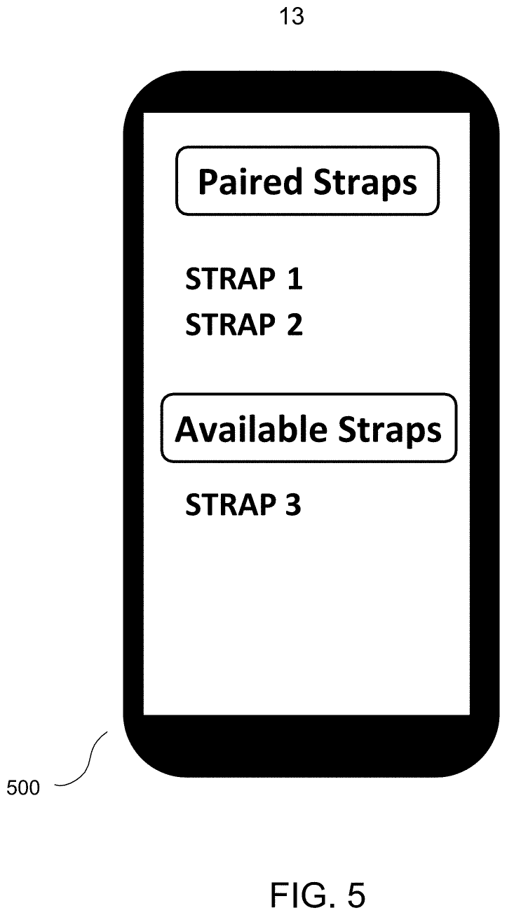

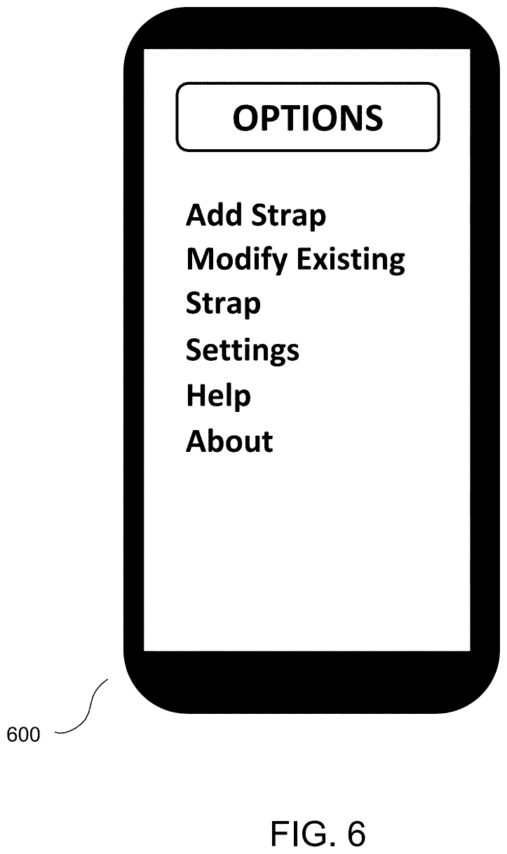

FIG. 5 shows an illustrative example 500 wherein the electronic device is coupled with two straps, Strap 1 and Strap 2. It is further shown that Strap 3 is available for pairing. FIG. 6 shows an illustrative example 600 wherein the application running on the electronic device shows different options available for monitoring the performance of the straps. The options described in the figure are merely illustrative in nature.

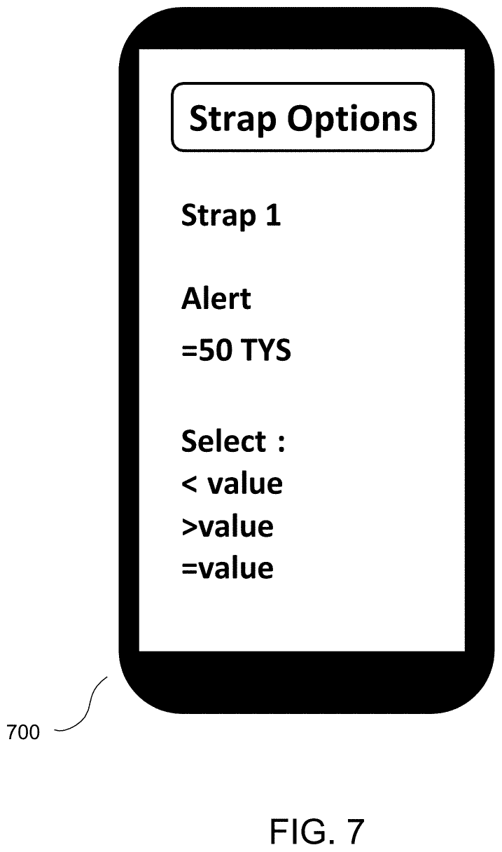

FIG. 7 shows an illustrative example 700 wherein an alert condition has been set for “Strap 1”. In the example shown in 700, three different options may be available such as “< value”, “> value”, and “= value”. In one example, “< value” may include option to create an alert if the unit value goes lesser than a pre-set value. Similarly, “> value” may include an option to create an alert if the unit value goes higher than a pre-set value. Further, “= value” may include an option to create an alert of the unit value is equal to a pre-set value. In the example shown in 700, the alert option has been set to a condition “=50 TYS” which means that an alert will be triggered if the TYS of Strap 1 reaches a value equaling to 50 TYS.

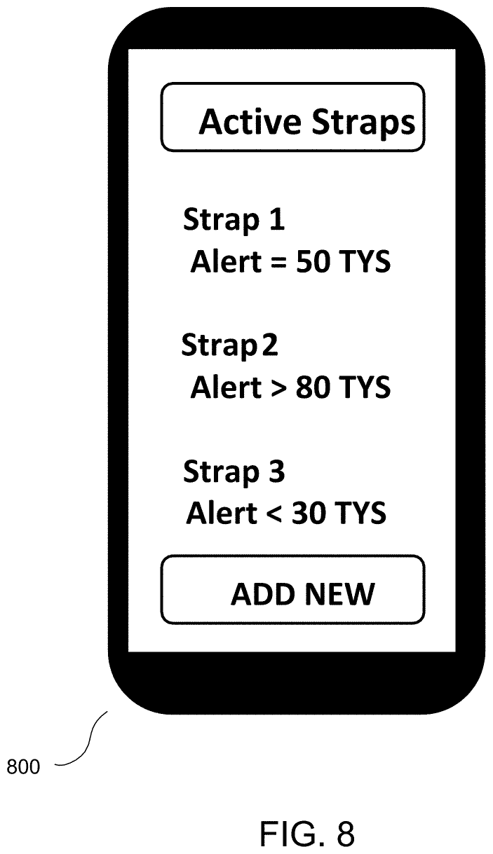

FIG. 8 shows an illustrative example 800 wherein active straps and their alert conditions have been set. As shown in the figure, an alert is generated if TYS of Strap 1 equals to 50 TYS. In case of Strap 2, an alert is generated if TYS of Strap 2 is grater than 80 TYS. And in case of Strap 3, an alert is generated if TYS of Strap 3 is lesser than 30 TYS.

The performance of the strap is determined based on one or more physical parameters associated with it including tensile strength, shear stress, tensile yield, and the like. The electronic device may be configured to receive TYS of the strap that is used to tie a load and notify the user if the load is too tight or too loose. It may also notify the user via the electronic device if the strap fails based on the TYS value receive from the strap monitor.

The electronic device determines that the load is too tight if the received TYS is greater than a preset high TYS value. Further it determined that the load is loose if the received TYS is lesser than a preset low TYS value. Furthermore, it is determined if the strap has failed if the received TYS is lesser than a preset critical TYS value.

A single application running in an electronic device may communicate with multiple strap monitors attached to multiple straps which makes the device much efficient and robust in practical use cases. Furthermore, the strap monitor may come in clamshell cases thereby protecting the device against physical wear and tear that are common with transportation. The clamshell design may protect the strap monitor against rough usage, weight, stress, changing weather conditions, heat, cold, rains, and the like.

The electronic device wherein the application for monitoring the performance of the strap is setup may comprise of a processor, a memory, a database, a network card, and I/O devices. Example processor can be custom made or commercially available processor, a central processing unit (CPU), an auxiliary processor, a semiconductor-based microprocessor (in the form of a microchip or chip set, for example), a macro processor, or generally any device for executing computer-readable program code. In one example the processor may be an ARM based processor.

Example memory may be a computer-readable storage medium. In some examples, memory can have a distributed architecture, where various components are situated remote from one another may be used. Processors may be configured to execute software stored within associated one of the memories, to communicate data to and from the memory, and to generally control operations of applications running in memory pursuant to the computer-readable program code.

The application for monitoring the performance of the straps may be a non-transitory program code that may be stored in any storage means. The program code may be compiled and loaded as an application to the memory of the electronic device. The processor may be used to run the application loaded in the memory. Different modules of the application may configure the electronic device to pair with the strap monitor via the network card present in the electronic device. The application may further allow the electronic device to continuously receive data from the sensors of the strap monitor. The application further processes this data to determine the physical parameters of the strap and may generate an alert if the values of the calculated physical parameters are within the range that is specified by the user.

The terms “straps”, “tie down straps”, “cables”, “strap-based fasteners” and “ratchet straps” have been used interchangeably throughout this document. The meaning of these terms remains the same and usage does not affect the essence and spirit of this invention. The terms have been used based on their context to suit the examples described herein and does not limit the scope of this invention either. A person ordinarily skilled in the art may readily understand that context in which these terms are used throughout this document.

Examples described herein can also be used in various other scenarios and for various purposes. It may be noted that the above-described examples of the present solution are for the purpose of illustration only. Although the solution has been described in conjunction with a specific embodiment thereof, numerous modifications may be possible without materially departing from the teachings and advantages of the subject matter described herein. Other substitutions, modifications, and changes may be made without departing from the spirit of the present solution. All of the features disclosed in this specification (including any accompanying claims, abstract and drawings), and/or all of the steps of any method or process so disclosed, may be combined in any combination, except combinations where at least some of such features and/or steps are mutually exclusive.

The terms “include,” “have,” and variations thereof, as used herein, have the same meaning as the term “comprise” or an appropriate variation thereof. Furthermore, the term “based on,” as used herein, means “based at least in part on.” Thus, a feature that is described as based on some stimulus can be based on the stimulus or a combination of stimuli including the stimulus.

The present description has been shown and described with reference to the foregoing examples. It is understood, however, that other forms, details, and examples can be made without departing from the spirit and scope of the present subject matter that is defined in the following claims.

What is claimed is:

1. An apparatus for monitoring performance of a tie down strap comprising:
a tie down strap;
a strap monitor attached to the tie down strap, wherein the strap monitor continuously monitors the physical parameters of the tie down strap; and
an electronic device communicatively coupled to the strap monitor, wherein the electronic device receives physical parameters of the tie down strap from the strap monitor to determine performance of the tie down strap.

2. The apparatus of claim 1, wherein the tie down strap comprises at least one of: a ratchet strap, a cable, or a chain.

3. The apparatus of claim 1, wherein the strap monitor comprises one or more sensors to determine the physical parameters of the tie down strap.

4. The apparatus of claim 3, wherein the one or more sensors comprises of a tension meter.

5. The apparatus of claim 1, wherein the performance of the tie down strap is determined based on one or more physical parameters associated with the tie down strap including tensile strength, shear stress, and tensile yield stress.

6. The apparatus of claim 1, wherein the electronic device is a smartphone, a tablet, a personalized digital assistant (PDA), a phablet, or a personal computer.

7. The apparatus of claim 1, wherein the strap monitor is protected by a clamshell shaped body to shield the strap monitor from external damages including weather conditions.

8. The apparatus of claim 1, wherein the electronic device can be used to set custom threshold values for the tie down strap for determining performance of the tie down strap.

9. The apparatus of claim 8, wherein the electronic device alerts a user if the tie down strap crosses the custom threshold values.

10. The apparatus of claim 8, wherein the electronic device can manage a plurality of tie down straps and strap monitors attached to the plurality of tie down straps.

11. The apparatus of claim 9, wherein the electronic device is further configured to:
receive tensile yield stress (TYS) of the tie down strap that is used to tie a load;
notify the user that: the load is too tight, the load is loose, or the tie down strap has failed based on the received TYS.

12. The apparatus of claim 11, wherein the electronic device determines that: the load is too tight if the received TYS is greater than a preset high TYS value, the load is loose if the received TYS is lesser than a preset low TYS value, or the tie down strap has failed if the received TYS is lesser than a preset critical TYS value.
